(19) United States
(12) Patent Application Publication
(10) Pub. No.: US 2025/0077850 A1
(43) Pub. Date: Mar. 6, 2025

(54) FINE-TUNING GENERATIVE MODEL UTILIZING INSTANCES AUTOMATICALLY GENERATED FROM LESS COMPUTATIONALLY EFFICIENT DECODING AND SUBSEQUENT UTILIZATION THEREOF WITH MORE COMPUTATIONALLY EFFICIENT DECODING

(71) Applicant: GOOGLE LLC, Mountain View, CA (US)

(72) Inventors: Mara Finkelstein, Los Altos Hills, CA (US); Qijun Tan, Los Gatos, CA (US); Markus Freitag, Los Altos, CA (US); Apurva Pradip Shah, Burlingame, CA (US)

(21) Appl. No.: 18/823,288

(22) Filed: Sep. 3, 2024

Related U.S. Application Data
(60) Provisional application No. 63/536,650, filed on Sep. 5, 2023.

(51) Int. Cl. G06N 3/0475

(52) U.S. Cl. CPC G06N 3/0475

(57) ABSTRACT

Implementations disclose utilizing a less computationally efficient decoding method in automatically generating corresponding single generative content predictions for training instances and fine-tuning a student generative model based on those automatically generated training instances. Those implementations are further directed to then utilizing, in an inference time environment, the fine-tuned student generative model and a more computationally efficient decoding method in generating generative predictions—and without any utilization of the less computationally efficient decoding method in generating the generative predictions.

### BACKGROUND

Various generative models have been proposed that can be used to process natural language (NL) content and/or other input(s), to generate output that reflects generative content that is responsive to the input(s). As one example, neural machine translation (NMT) models have been proposed that can be utilized to process NL content that is in a source language (e.g., English) to generate output that reflects a translation, of the NL content, that is in a target language (e.g., Spanish). An NMT model can be trained for use in translating from a single source language to a single target language or can be trained for multilingual use in translating from any one of multiple source languages and/or to any one of multiple target languages. For example, a multilingual NMT model can be used to process source language NL content, along with an indication of the source language and/or the target language, and to generate output that reflects a translation of the NL content in the indicated target language.

As another example of generative models, large language models (LLM(s)) have been developed that can be used to process NL content and/or other input(s), to generate LLM output that reflects generative NL content and/or other generative content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”.

The output that is generated using a generative model is a sequence of probability distributions. For example, the output that is generated using an NMT or an LLM can be a sequence of probability distributions over a vocabulary, such as a vocabulary of words, word pieces, and/or other token(s).

There are many decoding methods available for decoding such a sequence of probability distributions, and the decoding method that is utilized in the decoding will impact which generative content is determined to be responsive to processed input. For example, performing beam search decoding on a given sequence of probability distributions can result in determining first generative content, performing greedy decoding on the same given sequence of probability distributions can result in determining disparate second generative content, performing random sampling decoding on the same given sequence of probability distributions can result in determining disparate third generative content, etc.

For some tasks and/or for some generative models, certain decoding methods have been found to result in generative content that, at least when considered across a variety of outputs generated using a generative model for a variety of inputs, satisfies one or more desirable objective criteria. For example, for NMT models and/or for NMT tasks, certain decoding methods, such as quality estimation (QE) reranking and Minimum Bayes' Risk (MBR) decoding, have been found to result in generative content that reflects translations that satisfy one or more objective accuracy criteria. For instance, such translations can, at least when considered across a variety of outputs generated using a generative model for a variety of inputs, be more accurate than translations obtained from alternative decoding methods such as beam search decoding and greedy decoding. Put another way, when QE reranking or MBR decoding are utilized to decode a sequence of probability distributions that are generated based on processing of input reflecting a source language NL segment, it has been found that the determined generative content, from such QE reranking or MBR decoding, is more likely to be accurate than if one or more alternative decoding methods (e.g., beam search or greedy decoding) were instead utilized in the decoding to determine the generative content.

However, it is often the case that certain decoding method(s), that satisfy the one or more objective criteria, are less computationally efficient than are alternative decoding method(s) that fail to satisfy the one or more objective criteria. For a less computationally efficient decoding method, significant memory, processor, power, and/or other computational resource(s) can be required to process output, generated using a generative model, to determine generative content. This resource utilization can be significant on a per input basis, and even more significant when hundreds or thousands of inputs are being processed per minute, per second, or other interval. Also, due to the lesser computational efficiency, there can be significant latency in determining corresponding generative content and, as a result, in rendering corresponding generative content. Such latency can lead to prolonging of a user-to-computer interaction.

More generally, even though utilization of a less computationally efficient decoding method can result in determining improved generative content relative to utilization of a more computationally efficient decoding method—the computational inefficiencies of the less computationally efficient decoding method present various inference time drawbacks.

### SUMMARY

Implementations disclosed herein are directed to utilizing a less computationally efficient decoding method in automatically generating corresponding single generative content predictions for training instances and fine-tuning a student generative model based on those automatically generated training instances. Those implementations are further directed to then utilizing, in an inference time environment, the fine-tuned student generative model and a more computationally efficient decoding method in generating generative predictions—and without any utilization of the less computationally efficient decoding method in generating the generative predictions. Through fine-tuning of the student generative model based on the training instances that are generated using the less computationally efficient decoding method, output that is generated using the fine-tuned student generative model (e.g., a sequence of probability distributions) is more reflective of the improved accuracy and/or other objective criterion/criteria achieved by the less computationally efficient decoding method. This results in improved generative content, that is determined based on decoding the output generated using the fine-tuned student generative model, even when a more computationally efficient decoding method is utilized in generating the generative content.

Accordingly, implementations disclosed herein utilize an objectively better, but less computationally efficient, first decoding method in automatically generating training instances for fine-tuning a student generative model—then, at inference time, utilize an objectively worse, but more computationally efficient, second decoding method in decoding output that is generated utilizing the fine-tuned student generative model. In those implementations, the generative content that is generated at inference time from the more computationally efficient second decoding method is, as a result of the fine-tuning, improved relative to generative content that would be generated from the more computationally efficient second decoding method in decoding generative output generated utilizing a generative model that has not fine-tuned based on the automatically generated training instances. More particularly, the generative content that is generated at inference time from the more computationally efficient second decoding method becomes more akin to generative content that would be generated from the less computationally efficient first decoding method-without necessitating the less computationally efficient first decoding method be utilized at inference time.

In these and other manners, implementations seek to leverage the advantages of an objectively better, but less computationally efficient decoding method, through automatically generating training instances based on such a decoding method, fine-tuning a student generative model based on such training instances, and then utilizing the fine-tuned student generative model at inference time. Further, those implementations seek to mitigate latency and/or computational resource usage through utilization of a more computationally efficient decoding method at inference time. Accordingly, such implementations seek to balance accuracy of decoded generative content with latency and/or computational resource utilization. Even though the less computationally efficient decoding method is utilized in automatically generating training instances, implementations recognize that this enables utilization of the more computationally efficient decoding method in the inference time environment. Further, implementations recognize that the advantages of utilization of the more computationally efficient decoding method in the inference time environment can outweigh the utilization of computational resources needed in automatically generating training instances using the less computationally efficient decoding method. For example, the quantity of generative outputs that are processed, in the inference time environment utilizing the more computationally efficient decoding method, can quickly (e.g., within hours, days, weeks, or other temporal value) and vastly (e.g., by a factor greater than 10, greater than 100, or greater than another value) outweigh the quantity of generative outputs that are processed in automatically generating training instances using the less computationally efficient decoding method.

As one non-limiting example of some implementations disclosed herein, assume a plurality of source inputs that are each a corresponding source segment of natural language text. Each of the source segments can optionally lack any predefined association to any human specified ground truth generative content for the source segment. Some versions of those implementations can, for each of the source segments, process the source segment, in a single pass using a trained generative model, to generate corresponding generative model output that is a corresponding sequence of probability distributions. Further, those implementations can process the corresponding generative model output, using a less computationally efficient decoding method, to (a) generate multiple corresponding candidate generative predictions and to (b) select a corresponding single prediction from the corresponding candidate generative predictions. Yet further, those implementations can store, as a corresponding training instance, the source segment along with the corresponding single prediction. For example, a source segment can be a given source language segment that is in a source language, the candidate generative predictions for the source segment can be three or more candidate target language segments that are each a candidate translation of the given source language segment and that are each in a target language, the selected single prediction for the source segment can be a single one of those three or more candidate target language segments, and the training instance can specify the source segment as input and specify the selected single prediction as ground truth output.

Continuing with the example, the corresponding instances of training data can be used in fine-tuning a student generative model. In some implementations, the student generative model can be the trained generative model that was utilized in generating the training instances (e.g., a copy thereof). For example, the trained generative model can remain static during generating of the training instances, but the trained generative model (e.g., a copy thereof) can be updated by fine-tuning based on the corresponding instances of training data to thereby create a fine-tuned student generative model. In some other implementations, the student generative model can be an alternative trained generative model that differs from the trained generative model utilized in generating the training instances. For example, the student generative model can have a different architecture than the trained generative model (e.g., the student generative model can be an NMT model with a lesser quantity of parameters and/or layers than an LLM utilized as the trained generative model) and/or can have different initial weights that differ from those of the trained generative model that were held static during generating the corresponding instances of training data.

Continuing with the example, subsequent to generating the fine-tuned student generative model, the fine-tuned student generative model is utilized in an inference environment. Notably, in the inference environment, the more computationally efficient decoding method is utilized in processing outputs generated utilizing the fine-tuned student generative model, and generative predictions are based on the more computationally efficient decoding of the outputs. Notably, the less computationally efficient decoding method is not utilized in generating the generative predictions in the inference time environment. Accordingly, in the inference time environment, latency and/or computational resource utilization is mitigated through utilization of the more computationally efficient decoding method—while at least some benefits of the less computationally efficient decoding method are still obtained as a result of the fine-tuned student generative model being fine-tuned based on training instances automatically generated using the less computationally efficient decoding method.

In some implementations, a generative model described herein, such as an LLM, NMT model, or other model (e.g., multimodal generative model), can include at least hundreds of millions of parameters. In some of those implementations, the generative model includes at least billions of parameters, such as one hundred billion or more parameters. In some additional or alternative implementations, a generative model is a sequence-to-sequence model, is Transformer-based, and/or can include an encoder and/or a decoder. One non-limiting example of an LLM is GOOGLE'S Pathways Language Model (PaLM). Another non-limiting example of an LLM is GOOGLE'S Language Model for Dialogue Applications (LaMDA).

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart illustrating an example method of utilizing a less computationally efficient decoding method in automatically generating training instances, fine-tuning a student generative model based on those automatically generated training instances, and then utilizing, in an inference time environment, the fine-tuned student generative model and a more computationally efficient decoding method in generating generative predictions.

FIG. 3 depicts a flowchart illustrating an example of block 300 of FIG. 2.

FIG. 4 depicts a flowchart illustrating an example of block 400 of FIG. 2.

FIG. 5 depicts a flowchart illustrating an example of block 500 of FIG. 2.

FIG. 6 depicts an example architecture of a computing device, in accordance with various implementations.

### DETAILED DESCRIPTION

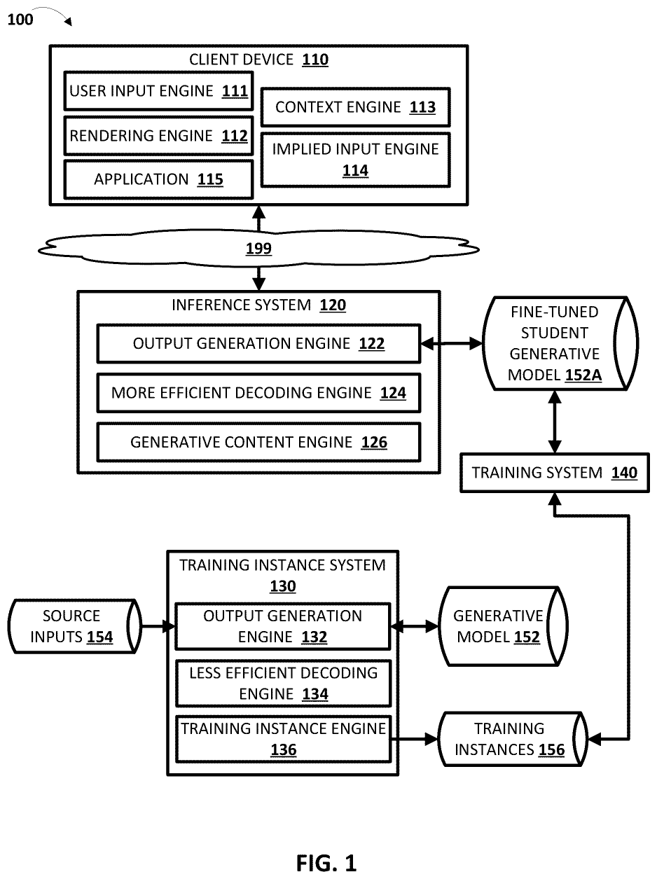

Turning now to FIG. 1, a block diagram of an example environment 100 that demonstrates various aspects of the present disclosure, and in which implementations disclosed herein can be implemented is depicted. The example environment 100 includes a client device 110, an inference system 120, a training instance system 130, and a training system 140. The example environment 100 further includes a source inputs database 154 and a trained generative model 152 that is utilized by the training instance system 130 in automatically generating training instances 156. The example environment 100 further includes a fine-tuned student generative model 152A that is fine-tuned, by the training system 140, utilizing the training instances 156.

Although illustrated separately, in some implementations all or aspects of inference system 120, training instance system 130, and/or training system 140 can be implemented as part of a cohesive system. For example, the same entity can be in control of the inference system 120, the training instance system 130, and the training system 140, and implement them cohesively. However, in some implementations one or more of the system(s) can be controlled by separate parties. In some of those implementations, one party can interface with system(s) of another party utilizing, for example, application programming interface(s) (APIs) of such system(s).

In some implementations, all or aspects of the inference system 120 can be implemented locally at the client device 110. In additional or alternative implementations, all or aspects of the inference system 120 can be implemented remotely from the client device 110 as depicted in FIG. 1 (e.g., at remote server(s)). In those implementations, the client device 110 and the inference system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries, that are included in requests, can be submitted and/or via which responses generated by generative model(s) (e.g., NMT model(s) and/or LLM(s)) and/or other response(s) to the requests can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the inference system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of new source input described herein, that can be received in an inference time environment, can be source input that is formulated based on user input provided by a user of the client device 110 and detected via user input engine 111. For example, the new source input can be a typed input that is typed via a physical or virtual keyboard, a suggested input that is selected via a touch screen or a mouse, a spoken voice input that is detected via microphone(s) of the client device, or an image input that is based on an image captured by a vision component of the client device 110 (e.g., NL text determined from OCR processing of the image).

In various implementations, the client device 110 can include a rendering engine 112 that is configured to provide content (e.g., a natural language based response generated by an NMT model or an LLM) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting user input (e.g., the supplemented or rewritten version can be that processed by a generative model in the inference environment), in generating an implied query (e.g., a query formulated independent of user input), and/or in determining to submit an implied query and/or to render result(s) (e.g., a NMT model generated response or LLM generated response) for an implied query.

In various implementations, the client device 110 can include an implied input engine 114 that is configured to: generate an implied source input independent of any user input directed to formulating the implied source input; to submit a request that includes the implied source input, optionally independent of any user input that requests submission of the request; and/or to cause rendering of a response for an implied source input, optionally independent of any user input that requests rendering of the response. For example, the implied input engine 114 can use current context, from current context engine 113, in generating an implied source input, determining to submit a request that includes the implied source input, and/or in determining to cause rendering of a response for the implied source input. For instance, the implied input engine 114 can automatically generate and automatically submit an implied source input based on the current context. Further, the implied input engine 114 can automatically push a response, to the implied source input, to cause the response to be automatically rendered or can automatically push a notification of the response, such as a selectable notification that, when selected, causes rendering of the response. As another example, the implied input engine 114 can generate an implied source input based on profile data (e.g., an implied query related to an interest of a user), submit the query at regular or non-regular intervals, and cause a corresponding response to be automatically provided (or a notification thereof automatically provided).

Further, the client device 110, the inference system 120, the training instance system 130, and/or the training system 140 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device 110 having a single user, it should be understood that such illustration is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

Generally, training instance system 130 automatically generates training instances that are used by training system 140 to fine-tune a student generative model, resulting in a fine-tuned student generative model 152A. The inference system 120 utilizes the fine-tuned student generative model 152A in an inference time environment in generating generative content predictions to provide responsive to requests from the client device 110 and/or from other computing device(s). As described in detail herein, in automatically generating the training instances, the training instance system 130 utilizes a first decoding method that is less computationally efficient (i.e., requires a greater quantity of computational resources) than is a disparate second decoding method that is utilized by the inference system 120 in generating generative content predictions to provide responsive to requests from the client device 110 and/or from other computing device(s).

Training instance system 130 is illustrated as including an output generation engine 132, a less efficient decoding engine 134, and a training instance engine 136.

In generating the training instance, the output generation engine 132 can select a source input from source inputs database 154. The output generation engine 132 can process the source input, using the generative model 152 and in a single pass over the generative model 152, to generate generative model output that is a sequence of probability distributions. In generating the training instance, the less efficient decoding engine 134 can process the generative model output, generated by the output generation engine 132, to determine a single prediction for the source segment. In processing the generative model output, the less efficient decoding engine 134 uses the less efficient first decoding method to decode the sequence of probability distributions of the generative model output.

In some implementations, in determining the single prediction for the source segment, the less efficient decoding engine 134 generates multiple candidate generative predictions based on the generative model output and selects the single prediction from among the multiple candidate generative predictions. For example, the less efficient decoding engine 134 can utilize epsilon sampling, of the sequence of probability distributions of the generative model output, to generate three or more candidate generative predictions. The less efficient decoding engine 134 can then utilize one or more objective utility functions to select a single one of the generated candidate generative predictions. For example, the less efficient decoding engine 134 can utilize a reference-based objective utility function such as a Minimum Bayes' Risk (MBR) scoring function and/or can utilize a reference-free objective utility function such as a quality estimation (QE) scoring function. For instance, the MBR scoring function can use BLEURT as a utility function and/or the QE scoring function can be MetricX-XXL-QE.

In generating the training instance, the training instance engine 136 can store, as a training instance of the training instances 156, the source input (selected by the output generation engine 132 and utilized in generating the generative model output) along with the single prediction (determined by the less efficient decoding engine based on the generative model output).

The training instance system 130 can generate multiple training instances, with each being generated based on a different source input of the source inputs database 154.

The training system 140 utilizes the training instances 156 to fine-tune a student generative model, resulting in a fine-tuned student generative model 152A. In some implementations, the student generative model that is fine-tuned can be the same as the generative model 152. For example, the student generative model that is fine-tuned can be initialized from the same generative model 152 and the same checkpoint. In some other implementations, the student generative model that is fine-tuned can be different from the generative model 152. For example, the fine-tuned student generative model 152A can have initial weights that are different than those of the generative model 152 and/or can be of a different architecture than the generative model 152. For instance, the generative model 152 can include more parameters than the fine-tuned student generative model 152A, making the fine-tuned student generative model 152A more computationally efficient (e.g., loadable with less memory resources and/or able to process input with less processor resources). As a particular instance, the generative model 152 can be an LLM with over one billion parameters, and the fine-tuned student generative model 152A can be an NMT model with less than half the quantity of parameters as the LLM.

In training the student generative model based on one of the training instances 156, the training system 140 can select one of the training instances, process source input of the selected training instance using the student generative model as currently trained to generate generative model output, and generate a loss based on comparing that generative model output to the single generative prediction of the training instance. The training system 140 can then update the student generative model based on the loss and, optionally, based on additional similarly determined loss(es) in batch training implementations. The training system 140 can fine-tune the student generative model based on multiple (e.g., all of) the training instances 156.

Inference system 120 is illustrated as including an output generation engine 122, a more efficient decoding engine 124, and a generative content engine 126.

In generating generative content to provide responsive to a request from the client device 110 and/or from other computing device(s), the output generation engine 122 can process an input, of the request, using the fine-tuned student generative model 152A and in a single pass over the fine-tuned student generative model 152A, to generate fine-tuned generative model output that is a sequence of probability distributions. The more efficient decoding engine 124 can then process the fine-tuned generative model output, generated by the output generation engine 122, to determine a generative content prediction for the input. In processing the fine-tuned generative model output, the more efficient decoding engine 124 uses the more efficient second decoding method to decode the sequence of probability distributions of the generative model output. For example, the more efficient second decoding method can be a greedy search method, a beam search method, or a sampling method (without any objective scoring of a sampled decoding).

The generative content engine 126 can cause the generated content prediction to be provided responsive to the request. For example, when the request is from the client device 110, the generative content engine 126 can cause the generated content prediction to be visibly and/or audible rendered by the rendering engine 112 of the client device 110. For instance, the generative content engine 126 can transmit data, to the client device 110, that is operable to cause the rendering engine 112 to render the generated content prediction. As another example, when the inference system 120 is implemented in cloud-based server(s) and the request is from other cloud-based server(s), the generative content engine 126 can cause the generated content prediction to be transmitted to the other cloud-based server(s) responsive to the request (e.g., along with an indication of the request to which the generated content prediction is responsive).

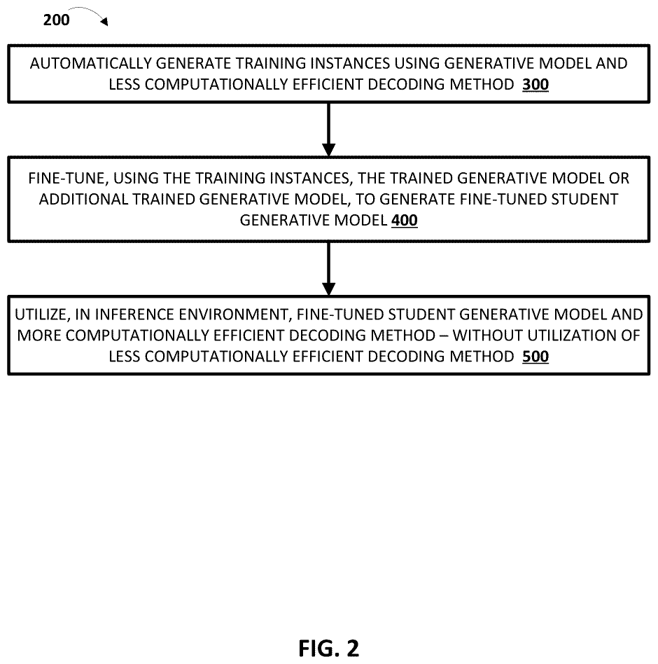

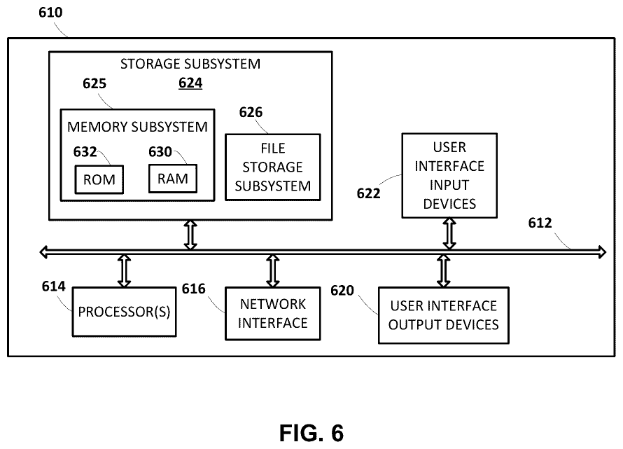

Turning now to FIG. 2, a flowchart is depicted that illustrates an example method 200 of utilizing a less computationally efficient decoding method in automatically generating training instances, fine-tuning a student generative model based on those automatically generated training instances, and then utilizing, in an inference time environment, the fine-tuned student generative model and a more computationally efficient decoding method in generating generative predictions. For convenience, the operations of the method 200 are described with reference to a system that performs the operations. This system of the method 200 includes one or more processors, memory, and/or other component(s) of computing device(s) (e.g., client device 110 of FIG. 1, client device 610 of FIG. 6, one or more servers, and/or other computing devices). Moreover, while operations of the method 200 are shown in a particular order, this is not meant to be limiting. One or more operations may be reordered, omitted, and/or added.

At block 200, the system automatically generates training instances using a generative model and a less computationally efficient decoding method. The less computationally efficient decoding method is less computationally efficient relative to a more computationally efficient decoding method that is utilized in block 500 (described below). For example, processing output (e.g., a sequence of probability distributions) utilizing the less computationally efficient decoding method can require a greater amount of memory, processor, power, and/or other computational resource(s) than does processing the same output utilizing the more computationally efficient decoding method.

At block 300, the system fine-tunes, using the training instances generated at block 200, the trained generative model of block 200 or an additional trained generative model, to generate a fine-tuned student generative model.

At block 400, the system utilizes, in an inference environment, the fine-tuned student generative model (fine-tuned at block 300) and the more computationally efficient decoding method in determining generative content in response to requests received in the inference environment. Block 400 can include determining the generative content utilizing the more computationally efficient decoding method and without any utilization of the less computationally efficient decoding method of block 300 and/or without any utilization of any other decoding method.

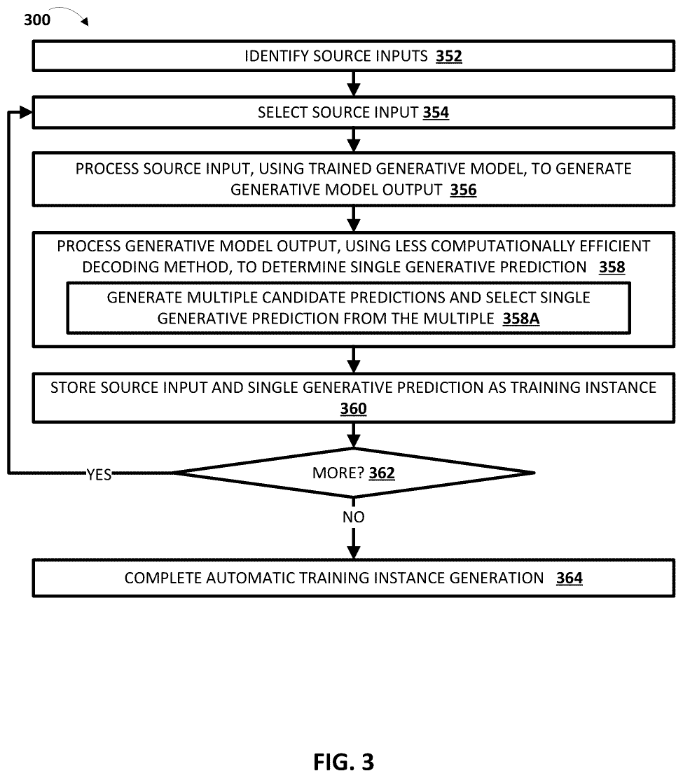

Turning now to FIG. 3, a flowchart is illustrated that depicts an example of block 300 of the method of FIG. 2.

At block 352 of the example of FIG. 3, the system identifies source inputs. For example, the source inputs can be NL segments that are each in a source language, such as NL segments that do not have any assigned pairing with human labeled ground truth translations in a target language.

At block 354 of the example of FIG. 3, the system selects one of the source inputs of block 352.

At block 356 of the example of FIG. 3, the system processes the source input, using a generative model, to generate generative model output. The generative model output can be a sequence of probability distributions over a vocabulary, such as a vocabulary of words, word pieces, and/or other token(s).

At block 358 of the example of FIG. 3, the system processes the generative model output, using a less computationally efficient decoding method, to determine a single generative prediction.

In some implementations, block 358 includes sub-block 358A, in which the system generates multiple candidate predictions and selects a single generative prediction from the multiple candidate predictions. For example, at sub-block 358A the system can utilize epsilon sampling to generate two or more candidate predictions, apply each of the candidate predictions to an objective utility function to generate a corresponding utility metric therefore, then select a single one of the candidate predictions, as the single generative prediction, based on the utility metrics (i.e., select the candidate prediction with the best utility metric). In some implementations, the objective utility function can be a reference-based or reference-free objective utility function.

At block 360 of the example of FIG. 3, the system stores the source input (of a most recent iteration of block 354) and the single generative prediction (of a most recent iteration of block 358) as a training instance.

At block 362 of the example of FIG. 3, the system determines whether to generate and store more training instances. If so, the system proceeds back to block 354 and selects an unprocessed source input. If not, the system proceeds to block 364. In some implementations, at block 362 the system determines whether to generate and store more training instances based on one or more criteria such as whether any unprocessed source inputs remain, whether a threshold quantity of training instances have been generated, whether a threshold duration of training instance generation has expired, and/or other criterion/criteria.

At block 364 of the example of FIG. 3, the system completes the current iteration of automatic training instance generations.

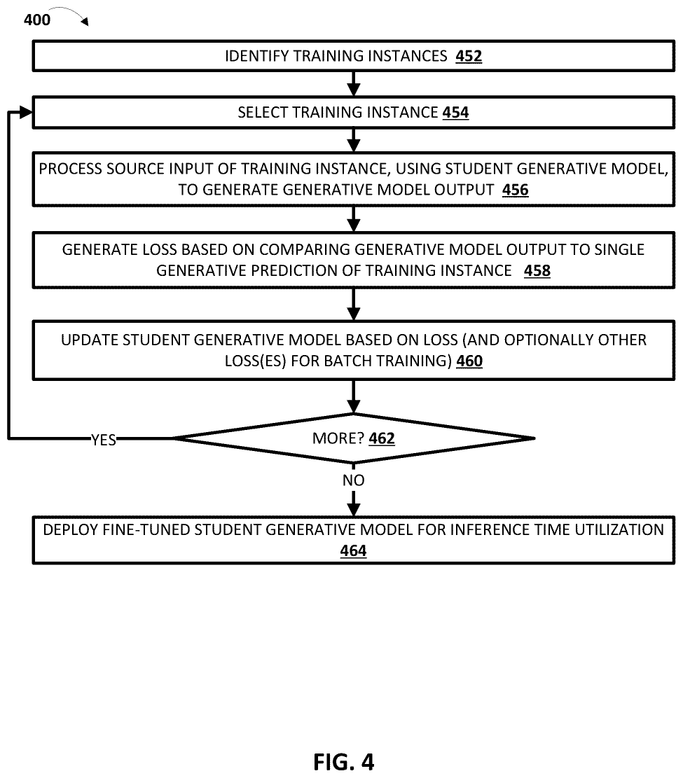

Turning now to FIG. 4, a flowchart is illustrated that depicts an example of block 400 of the method of FIG. 2.

At block 452 of the example of FIG. 4, the system identifies training instances automatically generated based on a less computationally efficient decoding method, such as training instances generated at block 300 of the method of FIG. 2.

At block 454 of the example of FIG. 4, the system selects one of the training instances.

At block 456 of the example of FIG. 4, the system processes a source input of the selected training instance (selected in a most recent iteration of block 454), using a student generative model, to generate generative model output. The generative model output can be a sequence of probability distributions over a vocabulary, such as a vocabulary of words, word pieces, and/or other token(s).

At block 458 of the example of FIG. 4, the system generates a loss based on comparing the generative model output (of a most recent iteration of block 456) to a single generative prediction of the training instance (selected in a most recent iteration of block 454). For example, the loss can be a function of how closely the generative model output conforms to the single generative prediction. For instance, the loss can be based on a negative log-likelihood score and/or a perplexity score. Those and/or other score(s) can optionally be generated based on comparing the single generative prediction to a given sequence of probability distributions over a vocabulary that is reflected in the generative model output (e.g., generated as a function of the probabilities for single generative prediction in the probability distributions).

At block 460 of the example of FIG. 4, the system updates the student generative model based on the loss and, optionally (e.g., in batch learning implementations), other loss(es) determined based on other of the training instances.

At block 462 of the example of FIG. 4, the system determines whether to perform further fine-tuning. If so, the system proceeds back to block 454 and selects another training instance of the training instances. If not, the system proceeds to block 464. In some implementations, at block 462 the system determines whether to perform further fine-tuning based on one or more criteria such as whether any unprocessed training instances remain, whether a threshold quantity of training instances have been processed, whether a threshold quantity of epochs of training have been performed, whether a threshold duration of fine-tuning has expired, and/or other criterion/criteria.

At block 464 of the example of FIG. 4, the system deploys the fine-tuned student generative model for inference time utilization.

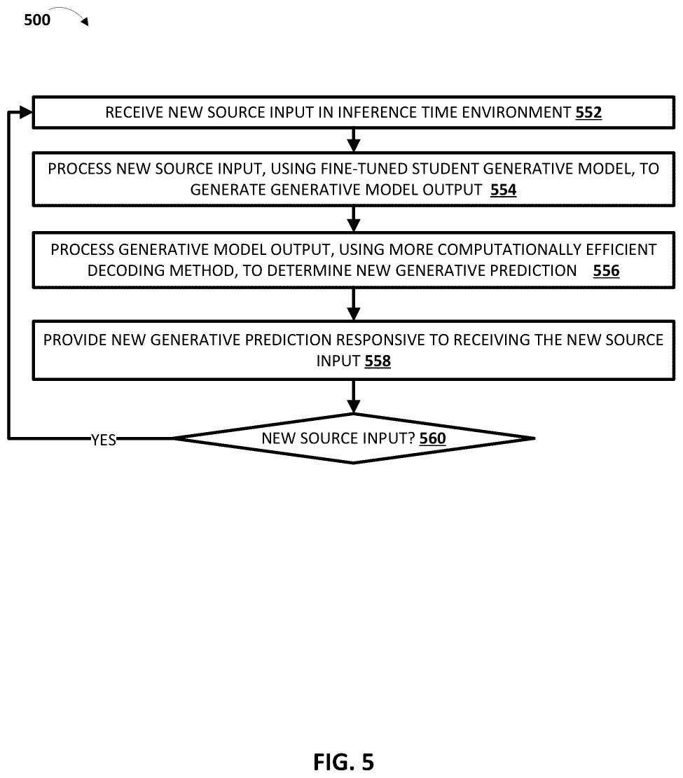

Turning now to FIG. 5, a flowchart is illustrated that depicts an example of block 500 of the method of FIG. 2.

At block 552 of the example of FIG. 5, the system receives new source input in an inference time environment. In some implementations, the new source input is received in a request from a client device. In some of those implementations, the new source input can be formulated based on user interface input at the client device, such as typed input, voice input, input to cause an image to be captured or selected, and/or other user interface input(s). The new source input can be, for example, a voice query, a typed query, an image-based query, a multimodal query (e.g., that includes voice input and an image), or an inferred/parameterless query. In some implementations, when the query includes content that is not in textual format, the system can optionally convert the query to a textual format or other format. For example, if the query is a voice query the system can perform automatic speech recognition (ASR) to convert the query to textual format. As another example, assume the query is a multimodal query that includes an image of an avocado and a voice input of “is this healthy”. In such an example, the system can perform ASR to convert the voice input to text form, can perform image processing on the image to recognize an avocado is present in the image, and can perform coreference resolution to replace “this” with “an avocado”, resulting in a textual format query of “is an avocado healthy”.

The new source input can alternatively be an implied query, such as one formulated and/or submitted independent of any user input directed to formulating the implied query. For example, the new source input can be an implied query that is automatically generated based on profile data and that is automatically submitted. For instance, the implied query can be “machine learning”, based on profile data indicating interest in machine learning topic(s). As another example, the new source input can be an implied query that is automatically generated and/or automatically submitted based on a current and/or recent context. As yet another example, the new source input can be an implied query that is submitted based on the user providing some indication of a desire to perform a search (e.g., pushing a search button, performing a search touch gesture, accessing a particular screen or state of an application), but that is generated automatically based on content currently being displayed at a client device, location, time of day, and/or other context signal(s).

At block 554 of the example of FIG. 5, the system processes the new source input, using a fine-tuned student generative model (e.g., fine-tuned based on block 400 of FIG. 2), to generate generative model output. The generative model output can be a sequence of probability distributions over a vocabulary, such as a vocabulary of words, word pieces, and/or other token(s).

At block 556 of the example of FIG. 5, the system processes the generative model output, using a more computationally efficient decoding method, to determine a new generative prediction. For example, the system can use a greedy decoding method, or another computationally efficient decoding method, to determine a single new generative prediction.

At block 558 of the example of FIG. 5, the system provides the new generative prediction responsive to receiving the new source input.

At block 560 of the example of FIG. 5, the system awaits another new source input and, if received, proceeds back to block 552 based on the new source input.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by processor(s) is provided and includes, for each of a plurality of source inputs: processing the source input, using a trained generative model, to generate corresponding generative model output; processing, using a less computationally efficient decoding method, the corresponding generative model output to (i) generate multiple corresponding candidate generative predictions, and (ii) select a corresponding single prediction from the corresponding candidate generative predictions; and storing, as a corresponding training instance, the source segment along with the corresponding single prediction. The less computationally efficient decoding method is less computationally efficient than is a more computationally efficient decoding method. The method further includes fine-tuning, using the corresponding instances of training data, the trained generative model or an additional trained generative model, to generate a fine-tuned student generative model. The method further includes, subsequent to generating the fine-tuned student generative model, utilizing, in an inference time environment, the fine-tuned student generative model and the more computationally efficient decoding method in generating generative predictions. The less computationally efficient decoding method is not utilized in generating the generative predictions in the inference time environment.

These and other implementations of the technology disclosed herein can include one or more of the following features.

In some implementations, processing, using the less computationally efficient decoding method, the corresponding generative model output to generate the corresponding candidate generative predictions and to select the corresponding single prediction from the corresponding candidate generative predictions includes: sampling from a sequence of probability distributions, reflected by the corresponding generative model output, to generate the corresponding candidate generative predictions; applying each of the corresponding candidate generative predictions to an objective utility function to generate a corresponding utility metric for each of the corresponding candidate generative predictions; and selecting the corresponding single prediction based on the corresponding utility metric for the corresponding single prediction. In some versions of those implementations, the sampling is epsilon sampling. In some of those or other versions, the objective utility function includes a reference-based objective utility function, such as an MBR scoring function. Optionally, where the objective utility function includes a reference-based objective utility function, applying a given prediction, of the corresponding candidate generative predictions, to the reference-based objective utility function includes: applying the given prediction in multiple passes using the reference-based objective utility function to generate multiple individual reference-based utility metrics. Each of the multiple passes are used to generate a corresponding one of the individual reference-based utility metrics based on a pairing of the given prediction with a corresponding other of the corresponding candidate generative predictions, and the corresponding utility metric, for the given prediction, is based on the individual reference-based utility metrics generated for the given prediction.

In some of those or other versions, the objective utility function includes a reference-free objective utility function, such as a quality estimation (QE) scoring function. Optionally, where the objective utility function includes a reference-free objective utility function, applying a given prediction, of the corresponding candidate generative predictions, to the reference-free objective utility function includes applying the given prediction and the source input using the reference-free objective utility function to generate a reference-free utility metric. The corresponding utility metric, for the given prediction, is based on the reference-free utility metric generated for the given prediction.

In some implementations, the objective utility function is represented by a separate trained neural network model that has fewer parameters than does the trained generative model, and applying each of the corresponding candidate generative predictions to the objective utility function to generate the corresponding utility metrics includes processing each of the corresponding candidate generative predictions using the separate trained neural network model.

In some implementations, the source inputs are natural language source inputs and the corresponding candidate generative predictions are corresponding natural language generative predictions. In some versions of those implementations, the natural language source inputs are in a first spoken language, the corresponding natural language generative predictions are translation predictions in a second spoken language, and the fine-tuned student generative model is a neural machine translation (NMT) model. For example, the trained generative model can be a large language model (LLM) and the fine-tuning can be of the additional trained generative model. In some other versions of those implementations, the fine-tuned student generative model is a large language model (LLM). In some of those other versions, the trained generative model is also the LLM or is an additional LLM.

In some implementations, the more computationally efficient decoding method, utilized in the inference time environment in generating the generative predictions is a beam search method, a greedy search method, or a sampling method.

In some implementations, utilizing, in the inference time environment, the fine-tuned student generative model and the more computationally efficient decoding method in generating the generative predictions includes: receiving new source input; processing the new source input, using the fine-tuned student generative model, to generate new generative model output; processing the new generative model output using the more computationally efficient decoding method to determine a new generative prediction; and providing the new generative prediction responsive to receiving the new source input. In some of those implementations, the new source input is generated based on user interface input at a client device and providing the new generative prediction includes causing the new generative prediction to be rendered at the client device. In some of those implementations, processing the new source input, processing the new generative model output, and providing the new generative prediction are performed by one or more server devices, the new source input is received in a request transmitted to the one or more server devices, and providing the new generative prediction includes transmitting the new generative prediction.

In some implementations, the less computationally efficient decoding method includes epsilon sampling and the more computationally efficient decoding method excludes any epsilon sampling.

In some implementations, the more computationally efficient decoding method includes beam search and the less computationally efficient decoding method excludes any beam search.

In some implementations, the more computationally efficient decoding method includes greedy decoding and the less computationally efficient decoding method excludes any greedy decoding.

In some implementations, a method implemented by processor(s) is provided and includes, for each of a plurality of source inputs: processing the source input, using a trained generative model, to generate corresponding generative model output; processing, using a less computationally efficient decoding method, the corresponding generative model output to (i) generate multiple corresponding candidate generative predictions, and (ii) select a corresponding single prediction from the corresponding candidate generative predictions; and storing, as a corresponding training instance, the source segment along with the corresponding single prediction. The less computationally efficient decoding method is less computationally efficient than is a more computationally efficient decoding method. The method further includes fine-tuning, using the corresponding instances of training data, the trained generative model or an additional trained generative model, to generate a fine-tuned student generative model. The method further includes, subsequent to generating the fine-tuned student generative model, causing the fine-tuned student generative model to be utilized, in an inference time environment, along with the more computationally efficient decoding method in generating generative predictions. The less computationally efficient decoding method is not utilized in generating the generative predictions in the inference time environment. In some versions of those implementations, causing the fine-tuned student generative model to be utilized, in the inference time environment, along with the more computationally efficient decoding method, can include transmitting the fine-tuned student generative model to one or more devices. In some of those versions, causing the fine-tuned student generative model to be utilized, in the inference time environment, along with the more computationally efficient decoding method, can further include transmitting instructions to the device(s), where the instructions specify to utilize the more computationally efficient decoding method in the inference time environment and/or that specify to not utilize the less computationally efficient decoding method.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
for each of a plurality of source inputs:
processing the source input, using a trained generative model, to generate corresponding generative model output;
processing, using a less computationally efficient decoding method, the corresponding generative model output to:
generate multiple corresponding candidate generative predictions, and
select a corresponding single prediction from the corresponding candidate generative predictions,
wherein the less computationally efficient decoding method is less computationally efficient than a more computationally efficient decoding method; and
storing, as a corresponding training instance, the source segment along with the corresponding single prediction;
fine-tuning, using the corresponding instances of training data, the trained generative model or an additional trained generative model, to generate a fine-tuned student generative model; and
subsequent to generating the fine-tuned student generative model:
utilizing, in an inference time environment, the fine-tuned student generative model and the more computationally efficient decoding method in generating generative predictions,
wherein the less computationally efficient decoding method is not utilized in generating the generative predictions in the inference time environment.

2. The method of claim 1, wherein processing, using the less computationally efficient decoding method, the corresponding generative model output to generate the corresponding candidate generative predictions and to select the corresponding single prediction from the corresponding candidate generative predictions comprises:
sampling from a sequence of probability distributions, reflected by the corresponding generative model output, to generate the corresponding candidate generative predictions; and
applying each of the corresponding candidate generative predictions to an objective utility function to generate a corresponding utility metric for each of the corresponding candidate generative predictions; and
selecting the corresponding single prediction based on the corresponding utility metric for the corresponding single prediction.

3. The method of claim 2, wherein the sampling is epsilon sampling.

4. The method of claim 2, wherein the objective utility function includes a reference-based objective utility function.

5. The method of claim 4, wherein applying a given prediction, of the corresponding candidate generative predictions, to the reference-based objective utility function comprises:
applying the given prediction in multiple passes using the reference-based objective utility function to generate multiple individual reference-based utility metrics, each of the multiple passes being used to generate a corresponding one of the individual reference-based utility metrics based on a pairing of the given prediction with a corresponding other of the corresponding candidate generative predictions;
wherein the corresponding utility metric, for the given prediction, is based on the individual reference-based utility metrics generated for the given prediction.

6. The method of claim 5, wherein the reference-based objective utility function is a Minimum Bayes' Risk (MBR) scoring function.

7. The method of claim 1, wherein the objective utility function includes a reference-free objective utility function.

8. The method of claim 7, wherein applying a given prediction, of the corresponding candidate generative predictions, to the reference-free objective utility function comprises:
applying the given prediction and the source input using the reference-free objective utility function to generate a reference-free utility metric;
wherein the corresponding utility metric, for the given prediction, is based on the reference-free utility metric generated for the given prediction.

9. The method of claim 8, wherein the reference-free objective utility function is a quality estimation (QE) scoring function.

10. The method of claim 1, wherein the source inputs are natural language source inputs and the corresponding candidate generative predictions are corresponding natural language generative predictions.

11. The method of claim 10, wherein the natural language source inputs are in a first spoken language, the corresponding natural language generative predictions are translation predictions in a second spoken language, and the fine-tuned student generative model is a neural machine translation (NMT) model.

12. The method of claim 11, wherein the trained generative model is a large language model (LLM) and wherein the fine-tuning is of the additional trained generative model.

13. The method of claim 10, wherein the fine-tuned student generative model is a large language model (LLM).

14. The method of claim 1, wherein the more computationally efficient decoding method, utilized in the inference time environment in generating the generative predictions is a beam search method, a greedy search method, or a sampling method.

15. The method of claim 1, wherein utilizing, in the inference time environment, the fine-tuned student generative model and the more computationally efficient decoding method in generating the generative predictions comprises:
receiving new source input;
processing new source input, using the fine-tuned student generative model, to generate new generative model output;
processing the new generative model output using the more computationally efficient decoding method to determine a new generative prediction; and
providing the new generative prediction responsive to receiving the new source input.

16. The method of claim 15, wherein the new source input is generated based on user interface input at a client device and wherein providing the new generative prediction comprises causing the new generative prediction to be rendered at the client device.

17. The method of claim 15, wherein processing the new source input, processing the new generative model output, and providing the new generative prediction are performed by one or more server devices, wherein the new source input is received in a request transmitted to the one or more server devices, and wherein providing the new generative prediction comprises transmitting the new generative prediction.

18. A system, comprising:
memory storing instructions;
one or more processors operable to execute the instructions to:
for each of a plurality of source inputs:
process the source input, using a trained generative model, to generate corresponding generative model output;
process, using a less computationally efficient decoding method, the corresponding generative model output to:
generate multiple corresponding candidate generative predictions, and
select a corresponding single prediction from the corresponding candidate generative predictions,
wherein the less computationally efficient decoding method is less computationally efficient than a more computationally efficient decoding method; and
store, as a corresponding training instance, the source segment along with the corresponding single prediction;
fine-tune, using the corresponding instances of training data, the trained generative model or an additional trained generative model, to generate a fine-tuned student generative model; and
subsequent to generating the fine-tuned student generative model:
cause the fine-tuned student generative model to be utilized, in an inference time environment, along with the more computationally efficient decoding method in generating generative predictions,
wherein the less computationally efficient decoding method is not utilized in generating the generative predictions in the inference time environment.

19. The system of claim 18, wherein in causing the fine-tuned student generative model to be utilized, in the inference time environment, along with the more computationally efficient decoding method, one or more of the processors are to transmit the fine-tuned student generative model to one or more devices.

20. The system of claim 19, wherein in causing the fine-tuned student generative model to be utilized, in the inference time environment, along with the more computationally efficient decoding method, one or more of the processors are further to transmit, to the one or more devices, instructions that specify to utilize the more computationally efficient decoding method in the inference time environment and/or that specify to not utilize the less computationally efficient decoding method.
